(19) United States
(12) Patent Application Publication
(10) Pub. No.: US 2026/0153851 A1
(43) Pub. Date: Jun. 4, 2026

(54) METHOD FOR ULTRA PRECISION TOOL WEAR CORRECTION WITH SCALING

(71) Applicant: Alcon Inc., Fribourg (CH)

(72) Inventors: David Andrew Icenogle, Brookhaven, GA (US); Cornelius Daniel Niculas, Suwanee, GA (US)

(21) Appl. No.: 19/405,514

(22) Filed: Dec. 2, 2025

Related U.S. Application Data
(60) Provisional application No. 63/727,294, filed on Dec. 3, 2024.

(51) Int. Cl. G05B 19/402; G05B 19/18; G05B 19/404; G05B 19/406

(52) U.S. Cl. CPC G05B 19/402; G05B 19/188; G05B 19/404; G05B 19/406

(57) ABSTRACT

The present disclosure is directed to correcting toolpath errors in ultra-precision machining of optical parts and mold inserts. A method includes machining a known optical surface to serve as a reference surface and capturing surface error data of the known optical surface using a metrology instrument. The surface error data may include an error map representing deviations from an intended design of the known optical surface. The method also includes smoothing the error map to reduce noise and highlight deviations, thereby creating a smoothed error map; deriving incident angles at which a cutting tool interacts with the known optical surface. The method also includes converting the smoothed error map into a derived angle space corresponding to the incident angles. The method also includes generating a corrected toolpath based on the derived angle space and applying the corrected toolpath to the machining equipment to correct the surface deviations.

This application claims the benefits under 35 USC § 119(e) of U.S. provisional application No. 63/727,294, filed on 3 Dec. 2024, incorporated by reference in its entirety.

### BACKGROUND

Ultra-precision machining is critical for manufacturing optical mold tooling used in molding contact lens molds for making contact lenses and in other tooling applications requiring high precision. A significant factor affecting the quality of the machined surfaces is the waviness and wear of cutting tools (typically diamond), which can lead to deviations in the final form tolerance and increased surface roughness. Conventional solutions attempt to correct form errors directly on the lathe, but may result in surface jitter, rendering these solutions unsuitable for optical mold inserts and tooling. Using the simplest surface to cut and measure (spherical) and scaling that surface to the desired geometry (aspheric, Toric, or freeform), significant productivity gains can be made.

### SUMMARY

This Summary introduces a selection of concepts in a simplified manner that are further described below in the Detailed Description. As such, this Summary is not intended to identify essential features of the claimed subject matter, nor is it intended to be used as an aid in determining the scope of the claimed subject matter.

The present disclosure is directed to correcting form errors in ultra-precision machining of optical mold inserts. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for correcting toolpath errors in ultra-precision machining of optical mold inserts or lenses (e.g., hard contact lenses, intraocular lenses, or plastic or glass lenses used for other purposes). The method also includes machining a known optical surface to serve as a reference surface; capturing surface error data of the known optical surface using a metrology instrument, the surface error data including an error map representing deviations from an intended design of the known optical surface; smoothing the error map to reduce noise and highlight deviations, thereby creating a smoothed error map; deriving incident angles at which a cutting tool interacts with the known optical surface; converting the smoothed error map into a derived angle space corresponding to the incident angles; and generating a corrected toolpath based on the derived angle space and applying the corrected toolpath to the machining equipment to correct the surface deviations. Other embodiments of this aspect include corresponding computer systems, apparatus, and computer programs recorded on one or more computer storage devices, each configured to perform the actions of the methods.

Implementations may include one or more of the following features. The method where the metrology instrument is a coordinate measuring machine configured to capture nanometer-level deviations. The method may include measuring a total error and deriving a root mean square error from the surface error data for an overall surface quality assessment. The incident angles are derived from a point cloud defining a geometry of the surface machined as a reference and the final optical mold insert. The method may include scaling the corrected toolpath for application on surfaces with different radii. The scaling factor is determined by a ratio of the radii of the reference surface and the target surface. The method may include scaling based on derived angle incidence. The method may include applying iterative corrections to the toolpath to account for cumulative tool wear. The corrected toolpath is applied to machining equipment configured for diamond turning. Generating the corrected toolpath further may include refining toolpath adjustments using local curvature data derived from the smoothed error map of the known optical surface. The corrected toolpath reduces peak-to-valley error to within an acceptable tolerance level. Implementations of the described techniques may include hardware, a method or process, or computer software on a computer-accessible medium.

One general aspect includes a system for correcting toolpath errors in ultra-precision machining of optical mold inserts or lenses. The system also includes a metrology instrument configured to capture surface error data of a machined optical surface; an error analysis module configured to smooth the surface error data and generate a smoothed error map, a toolpath transformation module configured to derive incident angles and convert the smoothed error map into a derived angle space, a toolpath correction module configured to generate a corrected toolpath based on the derived angle space, and a machining equipment configured to execute the corrected toolpath for machining the optical mold insert. Other embodiments of this aspect include corresponding computer systems, apparatus, and computer programs recorded on one or more computer storage devices, each configured to perform the actions of the methods.

Implementations may include one or more of the following features. The system where the metrology instrument is an interferometer or probe capable of capturing surface deviations with nanometer resolution. The error analysis module is further configured to calculate root mean square error values from the surface error data. The toolpath transformation module is configured to adjust the toolpath based on local curvature data of the optical mold insert. The system may include a control system configured to monitor tool wear (ongoing form deviation) and coordinate real-time data flow among system components. Implementations of the described techniques may include hardware, a method or process, or computer software on a computer-accessible medium.

One general aspect includes a user interface for correcting tool wear in ultra-precision machining processes. The user interface also includes a data input section configured to receive high-precision measurement data, including metrology data and point cloud data, from a metrology instrument; a mask diameter input section configured to allow a user to define a specific region of interest on a machined surface for which toolpath corrections are to be applied; a smoothing parameter input section configured to apply a smoothing algorithm to the high-precision measurement data to reduce noise and enhance surface deviations; a process initiation command configured to execute a toolpath correction algorithm based on input received via the data input section, the mask diameter input section, and the smoothing parameter input section; a status display section configured to provide real-time feedback on the progress and status of a toolpath correction process; and a graphical display configured to present a visual representation of the surface deviations and a corrected toolpath. Other embodiments of this aspect include corresponding computer systems, apparatus, and computer programs recorded on one or more computer storage devices, each configured to perform the actions of the methods.

Implementations may include one or more of the following features. The user interface where the graphical display includes a color-coded error map of the surface deviations. The user interface may include a peak-to-valley error display showing an improvement in one or more of the surface deviations after correction. The data input section is configured to accept data in multiple formats. The user interface may include an export function to save the corrected toolpath for later use or analysis. Implementations of the described techniques may include hardware, a method or process, or computer software on a computer-accessible medium.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is a block diagram of an ultra-precision form correction (UPFC) system, according to an example implementation.

FIG. 2 is a flow diagram depicting a method for correcting form errors in ultra-precision machining of optical mold inserts or lenses and scaling the correction to another geometry, according to an example implementation.

FIG. 3 is an illustration depicting the process of deriving incident angles and applying corrections, according to an example implementation.

FIG. 4 is a cutting tool angle map further depicting the process of error correction in ultra-precision machining by detailing the process of mapping cutting tool angles and understanding form errors, according to an example implementation.

FIG. 5 is an illustration depicting the process of scaling corrections between two surfaces with different radii, focusing on how to maintain precision in ultra-precision machining by accurately transferring error corrections from a smaller reference surface to a larger target surface, according to an example implementation.

FIG. 6 is a diagram of a 3D freeform surface, defined by a dense set of points with the incident angle derived at each point, according to an example implementation.

FIG. 7 is a wear corrector user interface 700 designed to facilitate the precise correction of tool wear in ultra-precision machining processes, according to an example implementation.

FIG. 8 are graphs depicting a detailed comparison of the surface deviations of a machined part before and after applying the toolpath corrections by the UPFC system, according to an example implementation.

### DETAILED DESCRIPTION

This disclosure described to a novel system and method for correcting tool wear in ultra-precision machining processes, particularly focused on the production of high-quality optical components such as optical contact lens mold inserts and other optical parts or mold inserts. The present disclosure addresses the issue of tool wear, which is a significant factor affecting the accuracy and quality of machined optical surfaces. As diamond tools, commonly used in ultra-precision machining, may have imperfect waviness and may wear down over time, these tools can introduce surface deviations that compromise the quality of the final product.

The present disclosure introduces a wear corrector user interface and associated system that utilizes high-precision measurement data, such as metrology data and point cloud data, to dynamically adjust the toolpath during the machining process. By analyzing the surface errors and calculating the necessary corrections, the system ensures that the final machined surface remains within the required tolerances, even as the cutting tool experiences wear.

A problem addressed by the present disclosure is the degradation of surface quality due to tool wear in ultra-precision machining. Traditional methods require frequent tool changes when surface deviations exceed acceptable limits, leading to increased downtime and production costs. Moreover, the use of highly precise and expensive diamond tools for finishing cuts further adds to the cost and complexity of the process.

The advantages of the present disclosure include, but are not limited to, the ability to correct part form without introducing jitter, ensuring smoothness and accuracy of the machined surface. The system significantly extends the usable life of ultra-precision diamond tools by enabling real-time corrections, thereby reducing the frequency of tool changes, and improving overall production efficiency. Additionally, the present disclosure allows for the use of less precise and cheaper diamond tools for finishing cuts, as the real-time corrections ensure that even these tools can produce surfaces that meet stringent quality standards. The system is also flexible, capable of applying corrections derived from one part geometry to another, ensuring that tools pass inspection when switching between different geometries, thus eliminating the need to measure a new geometry before creating a passing tool. Furthermore, the present disclosure is versatile, capable of applying corrections to both 2D (axis-symmetric) and 3D (freeform) tool geometries, saving metrology and process time, and making the system suitable for a wide range of ultra-precision machining applications.

As used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another implementation includes from the one particular value and/or to the other particular value. Similarly, when values are expressed as approximations, by use of the antecedent “about,” it will be understood that the particular value forms another embodiment.

“Contact Lens” refers to a structure that can be placed on or within a wearer's eye. A contact lens can correct, improve, or alter a user's eyesight, but that need not be the case. A contact lens can be of any appropriate material known in the art or later developed, and can be a soft lens, a hard lens, or a hybrid lens.

A “lens insert” refers to any 3-dimensional article which has a dimension of at least 5 microns but is smaller in dimension sufficient to be embedded in the bulk material of an embedded contact lens and which is made of a polymeric material that is different from the bulk material.

An “optical mold insert” refers to a precision-engineered component used to form high-quality optical surfaces on products such as contact lenses or lens inserts. An optical mold insert defines the exact surface curvature of a mold, allowing for high-accuracy replication in optical production.

“Waviness” refers to a periodic deviation of the radius of a tool from an ideal arc, resulting in slight undulations on the machined surface. This deviation impacts the uniformity of the toolpath, affecting surface quality and necessitating correction.

“Form” refers to the general shape or contour of an object or machined surface, specifically the geometric outline as defined by precise dimensions and tolerances.

“Final form” refers to the shape of a machined surface after all form corrections have been applied, reflecting the intended specifications and achieving the desired quality and tolerance levels.

“Desired form” refers to the target geometric shape for a machined surface, typically defined by design specifications or functional requirements for optimal optical performance.

“Form tolerance” refers to the allowable variation in the form of a machined surface from its desired geometric shape, often specified in microns or nanometers for high-precision applications.

“Surface roughness” refers to the degree of irregularity on a machined surface, typically characterized by peaks and valleys. High surface roughness can impact the performance of optical components by affecting light transmission and reflection.

“Form errors” refer to deviations in the machined surface from the desired geometric shape or “ideal form” of the optical mold insert. These deviations can result from factors like tool wear, waviness of the cutting tool, or minor positioning errors within the lathe or milling tool setup.

Toolpath errors” are inaccuracies or misalignments in the predefined path that the cutting tool follows. Toolpath errors can arise as the machine executes the designed cutting trajectory, potentially deviating due to dynamic factors like cumulative tool wear or small tool positioning inconsistencies.

“Surface jitter” refers to the rapid, minor deviation on the surface resulting from instabilities or oscillations during the machining process. Surface jitter can degrade optical performance by introducing unintended irregularities on the surface.

“Surface deviations” refer to departures from the intended geometric surface, which may result from tool waviness, inaccuracies in the defined position of the tool within the machine, or minor shifts in the mounting configuration of the tool (tool table).

“Optical surface” refers to a precisely machined surface intended to interact with light, requiring smoothness and exact curvature for effective optical function, commonly found on lenses or mold inserts for optical applications.

“Surface error data” refers to high-precision measurement data collected to quantify the deviations between a machined surface and its intended design. This data serves as the basis for calculating and correcting toolpath errors.

“Known optical surface” refers to a reference surface machined with a defined geometry, often spherical, used as a baseline for deriving corrective toolpath parameters that can be scaled to other geometries.

“Cutting tool angle map” refers to a detailed illustration of the angles at which the cutting tool engages the surface during machining. This map supports error correction by aligning tool orientation with surface geometry.

“Diamond tooling” refers to precision tools with diamond cutting edges used in ultra-precision machining for their durability and ability to achieve smooth, accurate cuts on optical surfaces.

“Milling” refers to a subtractive manufacturing process that removes material using rotary cutters to achieve specific shapes and features on a surface of a part.

“Grinding” refers to a finishing process that uses abrasive wheels to refine the surface and achieve a high degree of smoothness and precision.

“Deterministic polishing” refers to a controlled finishing technique that polishes surfaces to an exact specification, often used to attain a flawless finish on optical components by compensating for surface deviations.

In accordance with the disclosed concepts and technologies, a lens insert has a thickness less than any thickness of an embedded contact lens in the region where the lens insert is embedded. A lens insert can be any object, can have any geometrical shape, and can have any desired functions.

The term “anterior surface,” “front surface,” “front curve surface” or “FC surface” in reference to a contact lens or a lens insert, as used in this application, interchangeably means a surface of the contact lens, or lens insert that faces away from the eye during wear. The anterior surface (FC surface) is convex.

The “posterior surface,” “back surface,” “base curve surface” or “BC surface” in reference to a contact lens or lens insert, as used in this application, interchangeably means a surface of the contact lens, or lens insert that faces towards the eye during wear. The posterior surface (BC surface) is concave.

A “central axis” in reference to a contact lens or lens body, as used in this application, means an imaginary reference line passing through the geometrical centers of the anterior and posterior surfaces of a contact lens or a lens body.

The present disclosure may be understood more readily by reference to the following detailed description of example implementations taken in connection with the accompanying drawing figures, which form a part of this disclosure. It is to be understood that the present disclosure is not limited to the specific apparatuses, methods, conditions, or parameters described and/or shown herein, and that the terminology used herein is for the purpose of describing particular implementations by way of example only and is not intended to limit the claims. Any and all patents and other publications identified in this specification are incorporated by reference as though fully set forth herein.

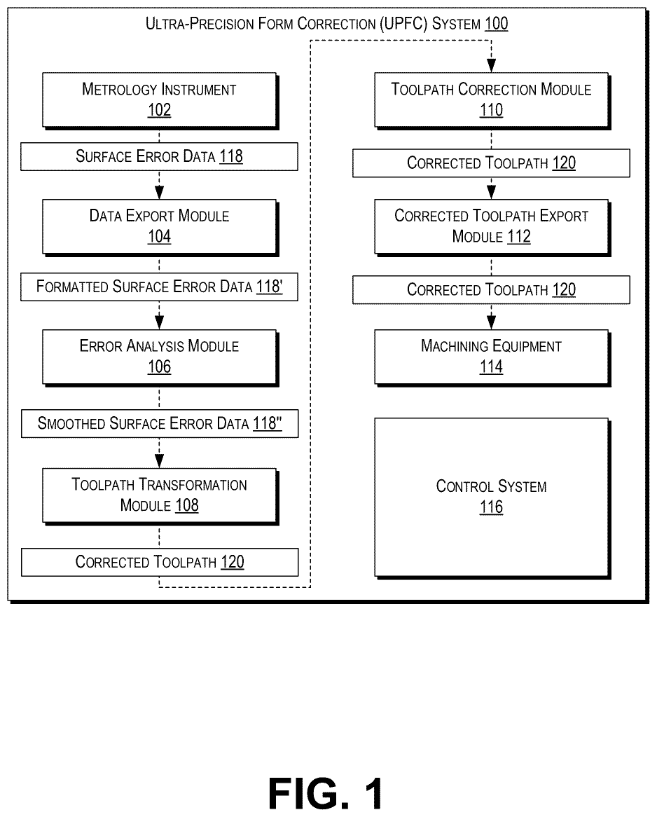

Turning to FIG. 1, shown is a block diagram of an ultra-precision toolpath correction (UPFC) system 100, according to an example implementation. The UPFC system 100 includes various hardware and software components. The software components are described herein as software modules. A software module refers to a unit of software that encapsulates a specific functionality or set of functionalities. Multiple software modules can be combined into one or more software applications, which may also provide a user interface that facilitates interaction with the UPFC system 100. The software modules can interact with other software modules and/or hardware components of the UPFC system 100 and/or other systems (e.g., remote systems) through interfaces and protocols, the details of which are well-known and will not be described in further detail herein.

In the illustrated example, the UPFC system 100 includes a metrology instrument 102, a data export module 104, an error analysis module 106, a toolpath transformation module 108, a toolpath correction module 110, a corrected toolpath export module 112, a machining equipment 114, and a control system 116. It should be understood, however, that the UPFC system 100 may include additional and/or alternative components. Although the UPFC system 100 is illustrated and described as a local system in which all components reside in the same location, some components may be accessible remotely via a connection to one or more networks, including, for example, a local area network (LAN), a wide area network (WAN), the Internet, and/or the like.

The metrology instrument 102 may be a coordinate measuring machine (CMM), an interferometer, or any other suitable metrology tool that outputs detailed surface error data 118. Although one metrology instrument 102 is shown, multiple metrology instruments 102 may be implemented for redundancy, calibration, and/or other purposes.

The metrology instrument 102 is a high-precision measurement device configured to capture surface error data 118 of optical mold inserts. The surface error data 118 describes deviations of a machined surface from its intended design specifications. The surface error data 118 captures minute differences between the actual topography of the surface and the ideal geometric form. These minute differences can be measured by the metrology instrument 102, for instance, with nanometer accuracy.

The surface error data 118 can include or can be used to determine an error map, which is a visual representation of these surface deviations, typically in the form of a two-dimensional (2D) or three-dimensional (3D) map. The error map highlights areas where the surface is higher (i.e., peaks) or lower (i.e., valleys) than the desired form, helping to identify specific regions that require correction. The error map aids in understanding the overall topography and pinpointing exact locations of deviations.

The surface error data 118 can include or can be used to determine a Peak-to-Valley (PV) error. The PV error a numerical value representing the difference between the highest peak and the lowest valley on the surface. The PV error quantifies surface roughness. High PV values indicate significant deviations that need correction, while low PV values suggest a smoother surface.

The surface error data 118 can include or can be used to determine a Root Mean Square (RMS) error. The RMS error is a statistical measure representing the average deviation of the surface points from the ideal surface. The RMS error can be calculated by taking the square root of the mean of the squares of all deviations. The RMS error provides a comprehensive metric for overall surface quality, helping to assess the general smoothness of the surface collectively.

The surface error data 118 can include or can be used to determine surface deviation vectors. Surface deviation vectors are vector representations of deviations at specific points on the surface, indicating the magnitude and direction of each deviation from the ideal surface. These vectors are useful for precise corrections, guiding how the toolpath should be adjusted to compensate for each deviation. Contour lines, or isolines, on the error map connect points with the same deviation value, helping visualize the gradient and distribution of surface errors. These lines assist in understanding the topography of the surface and identifying patterns in the deviations, especially useful in complex surfaces where errors vary significantly.

The surface error data 118 can include or be used to determine incident angles, which represent the angles at which the cutting tool interacts with the surface at specific points. These incident angles are critical for precise toolpath corrections. By analyzing incident angles, the UPFC system 100 can accurately modify the toolpath to account for form deviations, ensuring the cutting tool aligns with the optimal trajectory to smooth out errors effectively.

Toolpath corrections refer to the modifications made to the pre-defined path of the cutting tool, enabling the cutting tool to compensate for detected surface deviations. For instance, if the error map reveals a high peak or valley on the surface, the corrected toolpath adjusts the vertical or lateral position of the tool to mitigate these irregularities. In practice, toolpath corrections typically involve adjusting the depth of cut, but could also adjust lateral positioning or even feed rate modifications. For example, if a peak is detected, the corrected toolpath may reduce the cutting depth at that specific point to level the surface. Alternatively, in areas with a valley or depression, the toolpath may shift laterally to create a smoother, continuous surface without abrupt transitions. Additionally, in cases where more refined cuts are required in areas with high deviations, the feed rate might be modified to allow finer adjustments, particularly in ultra-precision applications like diamond turning, where nanometer-level accuracy is needed.

Incident angles also help determine the right orientation for toolpath corrections, ensuring that the cutting tool interacts with the surface at the most effective angle. The “right orientation” involves angling the cutting edge of the tool precisely to maintain a consistent cutting quality across the surface, enabling optimal application of corrective adjustments. For example, if the tool is cutting at a shallow angle (e.g., 15 degrees) relative to the surface, the orientation might need to be adjusted to a slightly steeper angle, allowing for a cleaner cut in regions with high peaks. On surfaces with more complex geometries, such as convex or Toric shapes where curvature changes continuously, the orientation of the tool might need dynamic adjustment as it moves across the surface. Typically, the cutting tool is held at a fixed angle, but if the orientation is dynamically adjusted the resultant incident angle of the tools across the insert must be calculated. For instance, on a steeply curved section, the UFCP system 100 might tilt the tool to a higher angle to achieve a uniform cut, thus avoiding any unintended undercutting or gouging. By aligning the tool orientation based on incident angles, corrections are applied smoothly and consistently, ensuring that each corrective cut improves the final surface quality, particularly for aspheric or freeform surfaces, where maintaining precise geometry is needed. In this way, even as tool wear and minor deviations accumulate, the method ensures high precision in achieving the desired geometric form.

The surface error data 118 can include or can be used to determine local curvature data. Local curvature data provides information on the curvature of the surface at various points, detailing how much the surface bends or curves, which can influence machining precision. The local curvature data helps refine the toolpath to accommodate complex surface geometries, ensuring that the adjustments are smooth and continuous, avoiding sharp changes that could impact surface quality.

The UPFC system 100 uses the surface error data 118 to dynamically adjust the toolpath, ensuring that machining maintains high precision throughout the process. For example, during the machining of an optical mold insert intended for molding contact lens molds, which in turn are used to make contact lenses, the metrology instrument 102 measures the machined surface, creating an error map that reveals areas of deviation from the ideal form. This error map might show various peaks and valleys in the surface geometry, which could result from tool wear, slight tool misalignments, or inconsistencies in material properties.

In one scenario, the error map could indicate a Peak-to-Valley (PV) error value of 150 nanometers (nm), signaling that the deviation is significant enough to impact the quality of the optical mold insert if left uncorrected. In this case, the UPFC system 100 uses the error map and deviation vectors to pinpoint both the exact locations and the degree of these deviations. For instance, a particular section of the surface might have a peak deviation of 100 nm over a narrow region, while another area may show a valley deviation of 50 nm over a broader region. To further quantify the overall surface quality, the Root Mean Square (RMS) error is calculated, providing a statistical measure of the average deviation across the surface. An RMS error of 20-30 nm might suggest a moderate level of deviation, which, while relatively uniform, still requires correction for precision applications like optical molds (ideally <10 nm RMS).

With this surface error data, the UPFC system 100 calculates the necessary corrections, specifically adjusting the toolpath to account for each deviation. Incident angles are derived for each deviation point, ensuring that the cutting tool approaches each region at an optimal angle. For instance, if the tool approaches a peak at a shallow angle, the UPFC system 100 may modify the incident angle to ensure the tool removes material in a controlled manner, minimizing any risk of over-cutting or tool bounce, which could create additional form errors. Likewise, when addressing a valley, the UPFC system 100 might adjust the angle to allow a slightly deeper cut without gouging adjacent areas.

The corrected toolpath 120 is then generated, with each segment of the path tailored to smooth out the detected peaks and valleys based on the surface error data. For example, if a peak deviation of 100 nm is detected at a specific point, the toolpath may adjust to cut only that area by precisely 100 nm, creating a smoother overall contour without affecting neighboring regions. Similarly, in areas with broader, shallow deviations, the UPFC system 100 may apply a softer correction to achieve a gradual blend, enhancing surface uniformity without abrupt transitions.

By effectively utilizing the surface error data 118, the UPFC system 100 not only achieves the desired form accuracy but also extends the lifespan of the machining equipment 114 (such as the cutting tool). With dynamic toolpath adjustments based on real-time data, the UPFC system 100 reduces unnecessary wear by preventing excessive or redundant cutting, which in turn minimizes the need for frequent tool changes. This approach maintains the high precision required for optical applications and ensures that the final product consistently meets stringent quality standards. In practical terms, a corrected toolpath that minimizes a PV error from 150 nm to under 50 nm could significantly improve the smoothness and performance of the optical mold insert, ultimately resulting in higher quality contact lenses with superior optical properties. The metrology instrument 102 can be physically connected to the data export module 104 via a data interface such as universal serial bus (USB) or Ethernet. The metrology instrument 102 can send the surface error data 118, including the detailed error map, to the data export module 104.

The data export module 104 receives the surface error data 118 and ensures this data is formatted correctly for further analysis. The data export module 104 then transfers the formatted surface error data 118′ to the error analysis module 106. In some implementations, the error analysis module 106 is executed on the UPFC system 100, such as via one or more processing units (not shown). Alternatively, a separate computer or server can execute the error analysis module 106, in which case the error analysis module 106 can communicate with the UPFC system 100 via a connection established through wired networks (Ethernet), wireless network (WLAN), or direct data transfer methods (USB). The error analysis module 106 can perform local curve fitting and smoothing on the formatted surface error data 118′ (e.g., the error map), reducing noise and highlighting significant deviations, thereby creating smoothed surface error data 118″. The smoothed surface error data 118″ provides a clearer representation of the surface errors that need correction.

The smoothed surface error data 118′ is then sent to the toolpath transformation module 108, which may be executed on the same or a separate computer/server as the error analysis module 106. In one example, the smoothed surface error data 118′ might indicate a series of peaks and valleys on the surface with deviations of 80 nm in certain regions and 150 nm in others, resulting from cumulative tool wear. The toolpath transformation module 108 uses this refined data to calculate specific adjustments to the toolpath, considering not only the location and magnitude of these deviations but also the condition of the cutting tool and the angles at which it interacts with the surface.

For instance, if the tool has developed a slight curvature due to wear, the transformation module 108 calculates toolpath adjustments to ensure that each cut compensates for this curvature, allowing the tool to maintain an accurate cut depth across the surface. In another example, if the tool angle data shows that the cutting tool approaches a specific area at an incident angle of 20 degrees, the transformation module 108 might adjust the angle slightly to avoid tool bounce, especially in regions where the surface slopes downward sharply.

Using the smoothed surface error data 118′ and these tool-specific considerations, the toolpath transformation module 108 transforms this information into a corrected toolpath 120. For example, if the error data identifies a peak of 80 nm in one area and a valley of 120 nm in another, the transformation module 108 generates a toolpath that instructs the cutting tool to reduce the cutting depth at the peak region by precisely 80 nm and increase it by 120 nm in the valley region, ensuring precise compensation for the detected deviations. These adjustments result in a refined toolpath that enables smooth, continuous machining while preserving the desired geometric form and accuracy of the surface.

The corrected toolpath 120 is then passed to the toolpath correction module 110, which integrates the corrections into the original toolpath. The toolpath correction module 110 can be executed on the same or different computer/server as the error analysis module 106 and/or the toolpath transformation module 108. The toolpath correction module 110 ensures that the corrected toolpath aligns with the machining requirements.

The corrected toolpath 120 is then sent to the corrected toolpath export module 112. The corrected toolpath export module 112 transfers the corrected toolpath 120 to the machining equipment 114 using a suitable data transmission method, such as USB, Ethernet, or proprietary machine interface protocols like MTConnect® or OPC UA®.

The machining equipment 114 is or include one or more cutting tools like diamond turning machines. The machining equipment 114 receives the corrected toolpath 120 from the corrected toolpath export module 112 and uses the corrected toolpath 120 to machine new parts (e.g., optical mold inserts) with high precision. The corrected toolpath 120 guides a cutting tool of the machining equipment 114, compensating for the detected errors and ensuring that the final machined surface meets the desired specifications.

Throughout the aforementioned process, the control system 116 interfaces with other hardware components. The control system 116 can be connected to the other hardware components via a network hub or switch. The control system 116 ensures real-time data flow and coordination among the hardware components. The control system 116 can use various communication protocols like Ethernet, Wi-Fi, or programmable logic controller (PLC) communication protocols to manage the workflow. The control system 116 can monitor tool wear, initiate measurements as needed, and coordinate data transfer between the metrology instrument 102, the error analysis module 106, and the machining equipment 114.

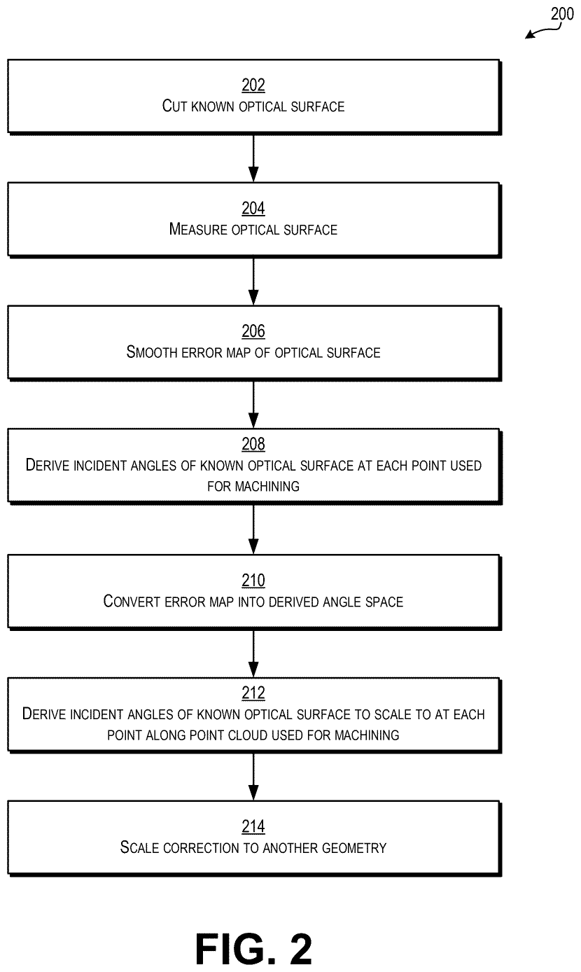

Turning to FIG. 2, shown is a flow diagram depicting a method 200 for correcting toolpath errors in ultra-precision machining of optical mold inserts, according to an example implementation. It should be understood that the operations of the method disclosed herein is not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

The method 200 for error correction in ultra-precision machining involves a series of steps designed to ensure precise toolpath adjustments while accounting for cumulative tool wear and surface deviations. For example, if the surface error data indicates a peak of 60 nm in one area and a valley of 90 nm in another, the method 200 generates toolpath adjustments that specifically address these deviations. In this instance, the toolpath would be adjusted to reduce the depth of cut by 60 nm over the peak area and increase it by 90 nm over the valley. This ensures that each region is machined to the desired level, smoothing out high and low points without impacting adjacent areas.

Additionally, if cumulative tool wear has caused a rounding of the cutting edge of the tool, the toolpath adjustments are typically axial (Z) corrections, they might also include lateral corrections to compensate. For example, as the tool moves along the surface, the method 200 may shift the toolpath slightly to the side to maintain contact at the correct cutting angle, counteracting the effects of tool wear and preventing undercutting.

The method 200 integrates detailed incident angle calculations to ensure these corrections are applied at the optimal orientation. For instance, if a sharp curvature requires the tool to approach at a 25-degree incident angle for precise material removal, the toolpath is adjusted accordingly. In areas with a more gradual slope, the angle might have a 10-degree approach, ensuring the tool removes material smoothly without creating chatter or surface tearing.

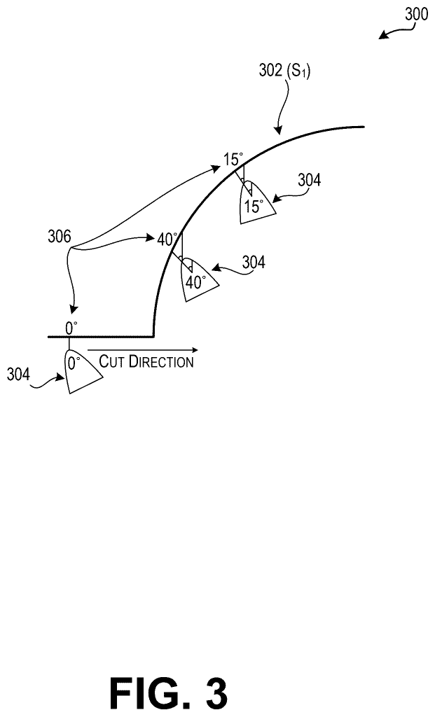

Serial corrections allow the method to apply these adjustments iteratively, ensuring cumulative accuracy. For instance, after an initial correction pass, a new measurement might reveal additional deviations due to ongoing tool wear. The method integrates this updated data into the next toolpath, refining each pass to compensate for both newly detected deviations and those already corrected, achieving the final precision required. As described with additional reference to FIGS. 1 and 3, this combination of precise toolpath adjustments, incident angle calculations, and serial corrections allows the method to maintain high accuracy and surface quality throughout the machining process, even as the tool wears.

The method 200 begins with cutting a known optical surface 300 (block 202). This involves machining an optical surface, such as a sphere, which serves as a reference for subsequent corrections. The known surface, labeled as S₁ in FIG. 3, is chosen for its ease of measurement. Following this, the optical surface 300 is measured using a sufficiently accurate method (block 204). A high-precision metrology instrument, such as the metrology instrument 102, captures the topography of the optical surface 300, generating an initial error map, E₁(r), which highlights deviations from the intended design.

The error map, E₁(r), of the optical surface 300 is smoothed (block 206). The error map, E₁(r), is processed to reduce noise and minor irregularities, focusing on significant deviations that need correction. For example, a significant deviation might be a localized peak of 120 nm on an otherwise smooth surface, which would cause optical distortions if left uncorrected. Similarly, a valley of 90 nm over a small area could disrupt the uniformity required for high-precision applications, like contact lens molding, where even slight dips can impact light transmission and product performance.

Smoothing ensures a clearer and more accurate representation of the surface errors. Once the error map is smoothed, the method 200 proceeds to derive the incident angles of the known optical surface at each point used for machining (block 208). These incident angles, denoted as A₁(r), represent the angles at which a cutting tool 304 (e.g., part of the machining equipment 114) interacts with the optical surface 300.

The incident angles are derived by analyzing the slope and orientation of the surface at each point along the optical surface relative to the position and orientation of the cutting tool. Specifically, for each point on the surface, the tangent plane is calculated to determine the local angle of the surface. The angle between this tangent plane and the approach vector of the cutting tool gives the incident angle. For example, if the tangent plane at a given point on the surface has a slope angle of 15° relative to the horizontal axis, and the cutting tool approaches this point perpendicularly, the incident angle would be calculated as the complement of the slope angle, resulting in a 15° incident angle.

To systematically calculate these angles across the surface, a point cloud defining the surface geometry is used, where each point includes coordinate data that allows the software to calculate the local slope and orientation. For each point in the point cloud, the local surface gradient is determined by comparing the elevations of surrounding points. The approach angle of the cutting tool is then compared to this gradient, producing a specific incident angle at each point, such as 0°, 15°, or 40°, as shown in FIG. 3.

Calculating these incident angles provides a precise understanding of how the toolpath should be adjusted to correct the detected errors, ensuring that the cutting tool consistently approaches each point on the surface at the optimal position based on the incident tool angle to reduce deviations and achieve the desired surface quality. By tailoring the incident angles in this manner, the method enables fine control over the toolpath, allowing for precise, localized adjustments in response to form errors detected in the smoothed error map.

Next, the error map is converted into a derived angle space (block 210). This involves mapping the smoothed error data, E₁(r), into the space defined by the incident angles, A₁(a). To accomplish this, the system takes each data point within the smoothed error map, which represents deviations on the surface at specific locations, and associates it with the corresponding incident angle at that point on the optical surface. For example, if a deviation of 80 nm is detected at a point with a calculated incident angle of 20°, this deviation is now represented within the derived angle space as) E₁(20°)=80 nm. This association allows each deviation to be organized by the angle at which the cutting tool will interact with that part of the surface.

Mapping the smoothed error data into this angle space translates deviations into toolpath adjustments that are not just based on the magnitude of the deviation but also on the orientation of the tool relative to the surface. This method aligns corrections to the specific contact angle of the cutting tool, so if the incident angle increases (e.g., moving from a 10° to a 30° contact), the system adjusts for this by recalculating the necessary toolpath corrections, accounting for the way the tool will impact the surface at this sharper angle.

The derived angle space also enables gradient-based corrections. For instance, if there is a sharp peak in the error data associated with a 45° incident angle, the toolpath adjustments will compensate by reducing the depth of cut to manage the steep approach and prevent overcutting. Similarly, in areas where the surface is nearly flat with a shallow incident angle, the adjustments might involve only minor depth corrections, ensuring a smooth and gradual approach to maintaining the desired surface contour.

The method 200 uses this derived angle space to calculate the incident angles of a scaled optical surface at each point along the point cloud used for machining (block 212). Each incident angle for the scaled surface, denoted as S_{2A}(r, θ), is adjusted for any changes in the surface geometry that occur during scaling. For example, if the scaled surface has a radius twice as large as the reference surface, the system recalculates the incident angles to fit this new geometry, ensuring that the corrections are appropriately scaled and applied. This approach allows the machining process to be adapted to variations in geometry while maintaining precision, resulting in consistent quality across differently sized or shaped surfaces.

To handle serial corrections and calculate the total error, the method 200 can include additional iterative steps. The initial corrected surface, CS₁(r), is obtained by adding the initial error map, E₁(r) to the known surface, S₁(r). As machining continues and additional measurements are taken, further corrections are applied iteratively. Each subsequent correction adds the new error map to the current surface, such as CS_{1A}(r)=CS₁(r)+E_{1A}(r) and CS_{1B}(r)=CS_{1A}(r)+E_{1B}(r). This process continues, stacking corrections on top of previous ones. The total error, E_{T}(r), at any point is the sum of all individual error maps, represented as E_{T}(r)=E₁(r)+E_{1A}(r)+E_{1B}(r)+ . . . . The total corrected surface, S_{1B}(r), is then given by S_{1B}(r)=S₁(r)+E_{T}(r).

The total error, E_{T}(r), is used with the incident angles, A_{T}(α), to generate the total correction at the incident angle, where A_{T}(α) is the total incident angle and AE_{T}(α) is the total error at that incident angle.

The method 200 scales the calculated corrections from the reference geometry to apply them to a different target geometry, allowing for adaptive machining across various optical surfaces (block 214). This step involves adjusting the corrected toolpath derived from the reference surface to accommodate changes in the size, shape, or curvature of the target surface, ensuring precision in the final machined product. The error map may also be extrapolated beyond the measured data to reduce the measurement area required.

To achieve this scaling, the method first identifies scaling factors based on the differences between the reference and target geometries. For example, if the target geometry has a larger radius than the reference geometry, the scaling factor would be derived from the ratio of these radii. This factor is then applied to modify the toolpath adjustments, accordingly, expanding or contracting them to match the new dimensions.

Additionally, scaling correction considers the local incident angles for each point on the target geometry. Since the incident angles influence how the cutting tool interacts with the surface, the method recalculates these angles based on the target surface's unique curvature and orientation. For instance, if a deviation on the reference surface requires a tool adjustment of 50 nm at a 30° incident angle, the target surface will require the same adjustment at the same incident angle and a different adjustment at a slightly different incident angle (e.g., 40°), reflecting the new curvature while maintaining corrective accuracy.

Through this process, the method ensures that corrections derived from the reference geometry are effectively translated onto the target geometry, preserving the intended form and quality. By adapting corrections based on both scaling factors and incident angles, the method enables precise, high-quality machining across a range of geometries, including aspheric, Toric, and freeform surfaces, without requiring entirely new error maps or corrective calculations for each unique surface.

Turning to FIG. 3, shown is an illustration depicting the process of deriving incident angles and applying corrections (shown generally at 300), according to an example implementation. Particularly, the known optical surface 302 (S₁) is shown with the cutting tool 304 moving in the direction labeled “cut direction.” Various incident angles 306, such as 0°, 15°, and 40°, represents the angles at which the cutting tool 304 interacts with the optical surface 302 (S₁). The incident angles 306 are used for accurately mapping the error data and applying corrections.

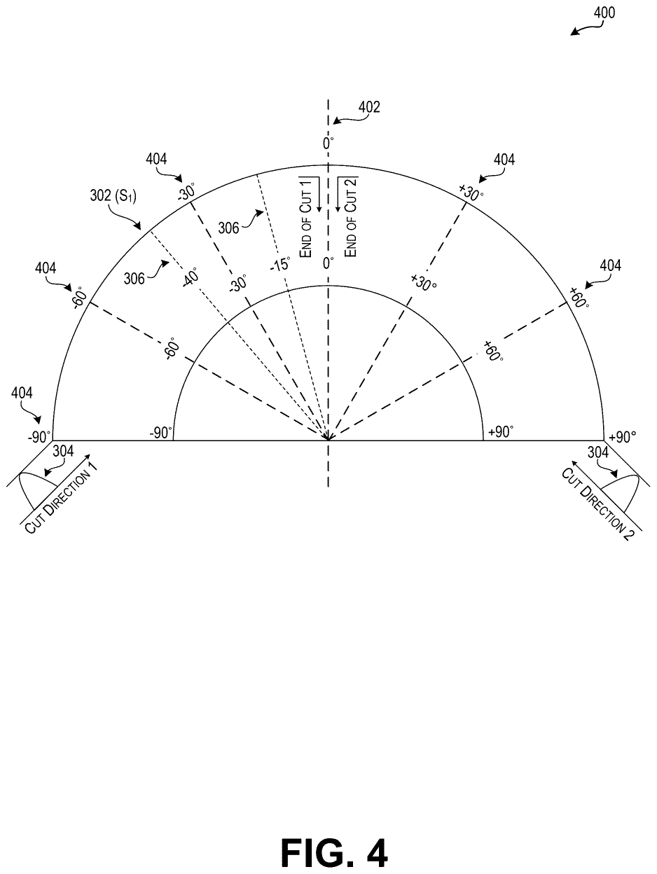

Turning to FIG. 4, shown is a cutting tool angle map 400 is shown further depicting the process of error correction in ultra-precision machining by detailing the process of mapping cutting tool angles and understanding form errors, according to an example implementation. The cutting tool angle map 400 provides a visual representation that complements the previously described steps, emphasizing how the cutting tool 304 interacts with the optical surface 300 and the nature of form errors encountered during machining.

A central vertical line 402 in the cutting tool angle map 400 represents the axis of part rotation, serving as the reference point for measuring angles. This axis is used for determining the incident angles 306 at which the cutting tool 304 interacts with the optical surface 302, represented by the curved line. The optical surface 302 serves as the baseline for error measurement and correction, with deviations from the optical surface 302 being mapped and used to adjust the toolpath.

Various angles 404 (e.g., −90°, −60°, −30°, +30°, +60°, +90°) in the cutting tool angle map 400 indicate the orientation of the cutting tool 304 relative to the optical surface 302 at different points. The angles 404 are used for deriving incident angles A₁(r) and for converting the error map into derived angle space, corresponding to blocks 208 and 210 in the method 200 described above. Specifically, these angles represent the orientation of the cutting tool 304 at various points on the optical surface 302, allowing for the calculation of incident angles A₁(r) based on the relative positioning between the cutting tool and the local surface geometry. For each point on the surface, the orientation angle of the tool provides a baseline for calculating how the tool will engage with the material at that specific location. For instance, if the cutting tool is oriented at +60° relative to the surface, this angle helps establish a precise incident angle that defines how steeply or shallowly the tool contacts the surface, thereby dictating the material removal rate and the resulting surface finish.

In addition to helping derive incident angles, the orientation angles 404 are integral to converting the error map into derived angle space. This conversion involves associating each detected deviation in the error map with the specific angle at which the tool will engage with that deviation during machining. For example, if a peak of 75 nm is detected at a region where the tool orientation is −30°, this deviation is mapped within derived angle space based on that specific orientation. By pairing each deviation with its corresponding orientation angle, the derived angle space provides a tailored toolpath that adjusts for these specific angles. This ensures that the toolpath corrections align precisely with the actual cutting conditions, adapting to both the direction and the degree of contact between the tool and the surface at each point.

Thus, the angles 404 not only define how incident angles A₁(r) are calculated but also facilitate a more nuanced error correction by transforming the error map into derived angle space. This approach aligns each correction with the exact conditions under which the cutting tool interacts with the surface, improving the accuracy of toolpath adjustments and ensuring consistent surface quality throughout machining.

Tool waviness refers to periodic deviations along the cutting edge of the cutting tool 304, affecting quality of the optical surface 302, while the cutting tool 304 wear refers to the gradual degradation of the cutting edge of the cutting tool 304 over time, which impacts the precision of the cut. Identifying and correcting these form errors is necessary for maintaining high precision in ultra-precision machining. The process of smoothing error maps (block 206) and calculating total error (serial corrections described above) addresses these form errors to ensure consistent quality.

The cutting tool angle map 400 can be an arc, ellipse, circle segment, lens barrel, or any other continuous shape that can extend beyond ±90°. This flexibility indicates that the method 200 can adapt to various geometries, making the method 200 versatile for different machining tasks. The ability to correct wear and form errors without needing to know the exact shape of the cutting tool 304 underscores the robustness of the method 200, particularly in comparison to conventional methods.

In the context of the method 200, the representation of the optical surface 302 (S₁) and the axis of part rotation helps in setting up the initial reference surface for measurement (block 202). Understanding the incident angles 306 and cut direction is used for accurate measurement and error mapping (block 204). Identifying form errors (e.g., tool waviness and tool wear) highlights the need for smoothing the error map to focus on significant deviations (block 206). The angles 404 shown in the cutting tool angle map 400 are used to derive the incident angles 306 and convert the error map into derived angle space, ensuring precise toolpath adjustments (blocks 208 and 210). Finally, the process of scaling corrections and applying them to the actual machining path involves calculating incident angles 306 along the point cloud, informed by the continuous curved shapes depicted in the cutting tool angle map 400 (block 212).

In summary, the cutting tool angle map 400 provides a visual framework that reinforces steps of the method 200 described above, particularly illustrating how the angles 404 of the cutting tool 304 and the types of form errors encountered play affect the ultra-precision machining process. By mapping these angles 404 and understanding the nature of form errors, the method 200 ensures accurate and efficient corrections, maintaining high precision and surface quality in the final machined product.

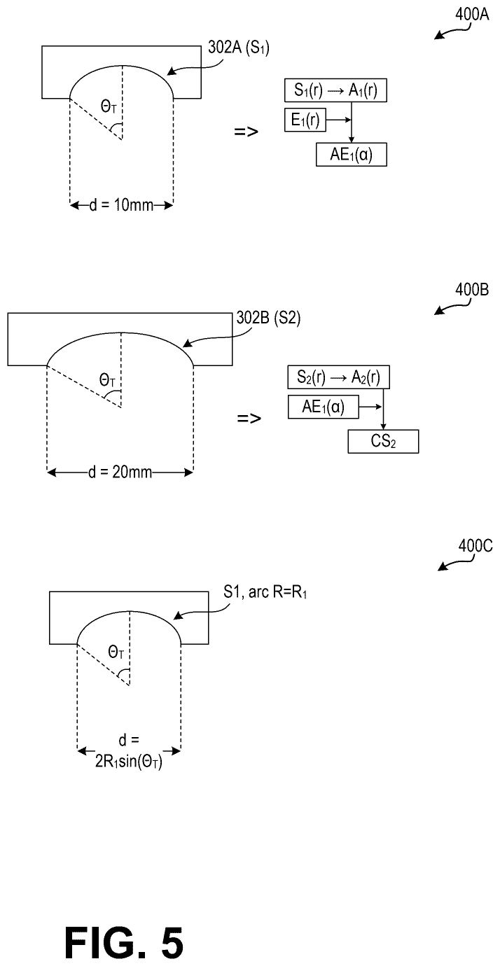

Turning to FIG. 5, shown is an illustration depicting the process of scaling corrections between two surfaces with different radii, focusing on how to maintain precision in ultra-precision machining by accurately transferring error corrections from a smaller reference surface to a larger target surface, according to an example implementation.

Shown generally at 500A, a surface 302A (S₁) is shown with an arc radius (R₁) and a diameter (d=10 mm), subtended by a total angle θ_{T}. The process begins by deriving the incident angles A₁(r) for the surface 302A (S₁) and generating an error map E₁(r). The error as a function of the incident angle, denoted as AE₁(α), is then calculated, establishing the error correction for the surface 302A (S₁).

Shown generally at 500B, a target surface (S₂) is displayed, which has a larger arc radius R₂ and a diameter (d=20 mm). Despite the difference in size, the total angle θ_{T} remains the same. The process involves deriving the incident angles A₂(r) for surface S₂ and applying the previously calculated error AE₁(α) from the surface S₁. This ensures that the error corrections are effectively transferred to the larger surface, resulting in the corrected surface CS₂.

Shown generally at 500C is a mathematical explanation for the scaling process. Particularly, 500C shows that the diameter (d) for any surface can be calculated using the formula d=2R₁ sin θ_{T}. This relationship illustrates that, for a given total angle θ_{T}, scaling the correction from a reference surface S₁ to a target surface S₂ is achieved by multiplying the correction values by the factor

$$\frac{{R}_{2}}{{R}_{1}} .$$

Overall, FIG. 5 emphasizes the mathematical basis for scaling error corrections when transitioning from one surface to another, demonstrating how the same principles can be applied to maintain precision across different surface geometries in ultra-precision machining.

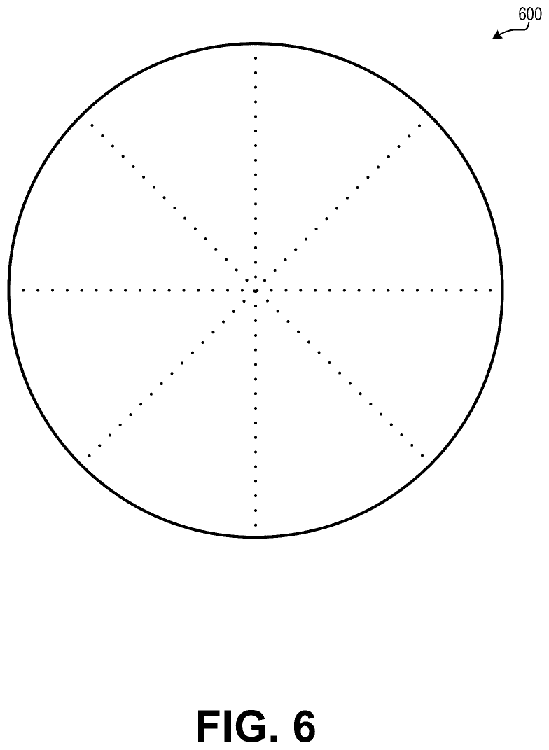

For 3D or freeform geometries, the process of error correction becomes more complex due to the intricacies of the surface. In such cases, the incident angle at each point on the surface, which is used for machining, can be precisely derived. This incident angle dictates how the cutting tool interacts with each point on the surface. Once these angles are calculated, the tool error, initially derived from a simpler, spherical reference surface, can be applied to correct the freeform geometry, even if the tool has existing form errors. FIG. 6 further clarifies this process.

Turning to FIG. 6, shown is a diagram of a 3D freeform surface 600 (SF) defined by a dense set of points, according to an example implementation. For clarity, the points illustrated in FIG. 6 are spaced more widely than they would be in practical application; typically, a denser array with a spoke of points every 1 to 5 degrees would be used. Such spacing is not depicted in FIG. 6 to avoid excessive visual clutter.

For each point (r, c) on the 3D freeform surface 600, the corresponding incident angle A_{F}(r, c) is calculated. These angles are essential for understanding how the cutting tool should be adjusted at each specific point on the 3D freeform surface 600.

Once the incident angles are determined, the total error AE_{T}, previously calculated from the spherical reference surface, is mapped to the 3D freeform surface 600. The final corrected surface CS_{F}(r, c) is obtained by adding the original 3D surface definition S_{F}(r, c) to the error correction AE_{T}(A_{F}(r, c)). This correction ensures that the final machined freeform surface adheres closely to the desired specifications despite any tool form errors.

It should be noted that freeform geometries typically involve a high density of points, which means a substantial amount of data needs to be processed. However, the accuracy of the corrections hinges on the precision of the calculated incident angles, making the incident angles the driving factor in the correction process. This method allows for the precise machining of complex 3D surfaces, maintaining the high standards required in ultra-precision manufacturing, including, for example, turning, milling, grinding, deterministic polishing, and any other ultra-precision manufacturing method.

In addition to the utility of scaling corrections to a larger surface, there is significant value in characterizing the cutting tool using a larger, more easily measurable part, and then scaling the correction down to a micro-lens. This approach is particularly advantageous because it simplifies the measurement and characterization process. Larger surfaces are generally easier to measure with high precision, allowing for a more accurate characterization of the cutting tool's form errors. Once these errors are identified and corrected on the larger surface, the same corrections can be effectively scaled down and applied to a micro-lens, which would otherwise be more challenging and time-consuming to measure due to its smaller size. This method enhances efficiency while maintaining the high level of precision required for ultra-precision machining of small, intricate components like micro-lenses.

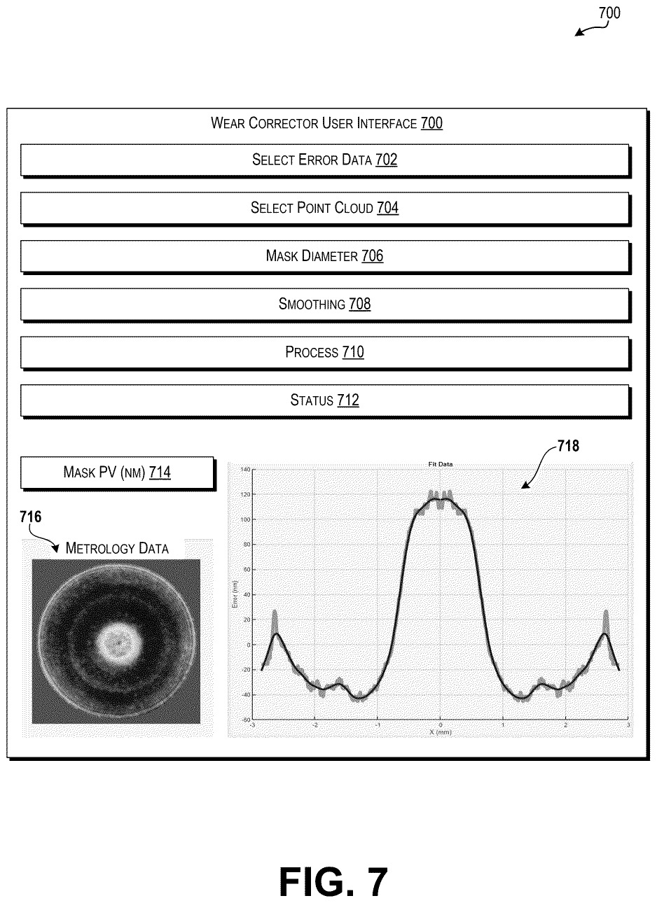

Turning to FIG. 7, shown is a wear corrector user interface 700 designed to facilitate the precise correction of tool wear in ultra-precision machining processes, according to an example implementation. The wear corrector user interface 700 is an integral component of a larger system, such as the UPFC system 100 or another system connected to the UPFC system 100, that ensures high accuracy in the machining of optical surfaces by dynamically adjusting the toolpath based on real-time wear data.

The wear corrector user interface 700 includes user input sections labeled “Select Error Data” 702 and “Select Point Cloud” (704). These sections allow a user to upload data files into the system. The error data represents high-resolution interferometric measurements of the machined surface, capturing detailed topographical features down to the nanometer level. The point cloud data corresponds to a dense collection of surface points, providing a comprehensive 3D representation of the surface geometry. These data inputs are used by the system to accurately map the current state of the tool wear against the desired surface specifications.

The wear corrector user interface 700 also includes a “Mask Diameter” input 706. This input allows the user to define the specific region of interest on the surface for which corrections are to be applied. By focusing the correction process on a particular area, the system can enhance precision, especially in cases where localized wear or defects are identified.

The wear corrector user interface 700 also includes a “Smoothing” parameter 708, which applies a smoothing algorithm to the raw error data. This reduces noise and isolates significant deviations from the ideal surface. The smoothing algorithm effectively filters out minor irregularities that may not require correction, thereby optimizing the correction process and preventing unnecessary adjustments that could introduce new errors.

Examples of smoothing algorithms that could be applied in this context include the moving average filter, which calculates the average of data points within a specified window to smooth fluctuations in the error data by replacing each point with the average of its neighbors, effectively reducing noise while preserving significant deviations. An additional example is a smoothed fitted spline function that is resampled at the desired positions. Another example is Gaussian smoothing, which applies a Gaussian kernel to the data, weighting nearby points more heavily than distant ones, thus reducing high-frequency noise and sharp outliers while preserving larger deviations for correction. The Savitzky-Golay filter is another example smoothing algorithm, fitting successive polynomial functions to subsets of the data to maintain the shape and features of the error profile while filtering out minor fluctuations. A median filter can be useful for removing isolated spikes or small irregularities, as it replaces each data point with the median of its neighbors, ensuring significant deviations are retained. Lastly, low-pass Fourier filtering transforms the error data into the frequency domain to remove high-frequency noise while retaining low-frequency components that represent substantial surface deviations, making it effective for data with periodic noise such as tool vibrations. These algorithms can each be tailored based on the desired level of smoothing and the characteristics of the noise and deviations in the machining data.

Once the user has configured these parameters, a “Process” command 710 can be selected to initiate the wear correction algorithm. This algorithm uses the input data to calculate the necessary adjustments to the toolpath, compensating for detected wear. The algorithm considers the incident angles of the cutting tool relative to the surface, as well as the previously characterized error data, to generate a corrected toolpath that realigns the cutting tool's interaction with the surface to achieve the desired form.

During processing, a “Status” display 712 provides real-time feedback to the user, indicating the progress of the correction process. This feature ensures that the user is informed of any issues or delays in the computation, allowing for timely intervention if necessary.

The corrected surface profile is quantitatively assessed using the “Mask PV (nm)” display 714, which shows the peak-to-valley measurement within the selected mask area in nanometers. This metric is used for evaluating the effectiveness of the correction, as it directly reflects the reduction in surface deviation achieved by the applied adjustments.

Visual feedback is provided through a pair of graphical displays. The first, labeled “Metrology Data” 716, presents a color-coded interferometric map of the surface, highlighting areas with significant deviations from the desired topography. This map provides an intuitive visual reference for the user to assess the current condition of the surface. The second graphical display, “Fit Data” 718, shows the error profile and the corresponding corrected toolpath. This graph allows the user to compare the original and adjusted surface profiles, verifying the accuracy and effectiveness of the corrections applied.

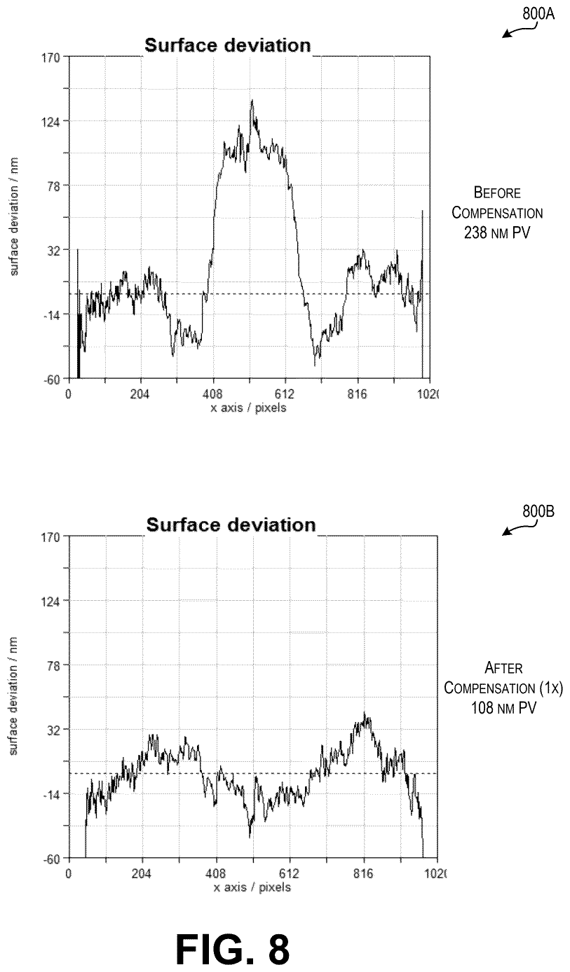

Turning to FIG. 8, shown are graphs 800A, 800B depicting a detailed comparison of the surface deviations of a machined part before and after applying the toolpath corrections by the UPFC system 100, according to an example implementation. The graph 800A shows surface deviation before compensation. The graph 800B shows surface deviation after compensation.

The graph 800A highlights the initial surface errors caused by diamond tool wear. This visualization helps users understand the extent and nature of the deviations that need correction. The PV error value before compensation provides a numerical measure of these deviations, offering a baseline for comparison.

The graph 800B represents the surface deviation of the same part after the toolpath corrections have been applied. The graph 800B should ideally display a smoother surface with fewer peaks and valleys, indicating that the corrections have been successful. The PV error value after compensation quantifies this improvement, showing a lower error value compared to the initial measurement.

For instance, if the initial PV error value was 238 nm and the corrected value is 108 nm, this indicates that the corrections have effectively halved the surface deviations, resulting in a much smoother and more precise part. This significant reduction in PV error demonstrates the effectiveness of the UPFC system 100 in maintaining high precision and quality in ultra-precision machining.

In the context of ultra-precision machining, optical mold inserts are used in processes like injection molding or diamond turning, where they are used to shape optical elements such as lenses, mirrors, or other complex optical surfaces. The quality of the optical mold insert directly affects the quality of the optical components produced, as any surface imperfections or deviations from the desired shape on the optical mold insert will be replicated in the final product.

For instance, in the production of contact lenses, an optical mold insert might be used to produce disposable contact lens molds which in turn are used to cast molding of contact lenses from a lens-forming composition. The manufacturing process begins with injection molding of disposable contact lens molds. A specific quantity of lens formulation (i.e., a polymerizable composition) is then introduced into the molding cavity of each contact lens mold. The lens formulation within the molding cavities can then be cured, e.g., actinically by a UV/visible light or thermally in an oven the temperature of which is carefully raised to approach a pre-defined temperature profile. After the curing step, the contact lens molds are opened, and the formed contact lenses are removed from the contact lens molds and further subjected to various post-molding processes, e.g., extraction, hydration, coating, packaging, autoclave, etc.

The optical mold insert's surface should be flawless, with an exact curvature and smoothness, to ensure that the contact lens cast-molded in contact lens molds obtained by using the optical mold inserts has the correct optical properties and is comfortable for the wearer.

Given the importance of surface quality, maintaining the precision of the optical mold insert during machining is essential. As machining tools wear down, these tools can introduce errors into the surface of the optical mold insert, which can degrade the optical performance of the components made from it. The tool wear corrector user interface 700 described above is designed to address this issue by allowing for real-time corrections to the machining process, ensuring that the optical mold insert remains within the stringent tolerances required for high-quality optical production.

A system and a method of the invention can find particular uses in making disposable molds for making contact lenses and/or lens inserts.

Molds for making contact lenses (or lens inserts) are well known to a person skilled in the art and, for example, are employed in cast molding. In general, a molds comprises at least two mold halves, one male half and one female mold half. The male mold half has a first molding (or optical) surface which is in direct contact with a polymerizable composition for cast molding of a contact lens (or an insert) and defines the posterior (back) surface of a molded contact lens (or a molded insert); and the female mold half has a second molding (or optical) surface which is in direct contact with the polymerizable composition and defines the anterior (front) surface of the molded contact lens (or molded insert). The male and female mold halves are configured to receive each other such that a lens- or insert-forming cavity is formed between the first molding surface and the second molding surface.

Methods of manufacturing mold halves for cast-molding a contact lens or an insert are generally well known to those of ordinary skill in the art. Examples of suitable processes for forming the mold halves are disclosed in U.S. Pat. Nos. 4,444,711; 4,460,534; 5,843,346; and 5,894,002 (herein incorporated by reference in their entireties).

Virtually all materials known in the art for making mold halves can be used to make mold halves for making contact lenses or lens inserts. For example, polymeric materials, such as polyethylene, polypropylene, polystyrene, PMMA, Topas® COC grade 8007-S10 (clear amorphous copolymer of ethylene and norbornene, from Ticona GmbH of Frankfurt, Germany and Summit, New Jersey), or the like can be used.

It should be understood that many variations are possible based on the disclosure herein. Although features and elements are described above in particular combinations, each feature or element is usable alone without the other features and elements or in various combinations with or without other features and elements.

While the disclosure has been described with reference to example implementations, it will be understood by those skilled in the art that a variety of modifications, additions and deletions are within the scope of the disclosure, as defined by the following claims.

What is claimed is:

1. A method for correcting toolpath errors in ultra-precision machining of optical parts or mold inserts, the method comprising the steps of:
machining a known optical surface to serve as a reference surface;
capturing surface error data of the known optical surface using a metrology instrument, the surface error data including an error map representing deviations from an intended design of the known optical surface;
smoothing the error map to reduce noise and highlight deviations, thereby creating a smoothed error map;
deriving incident angles at which a cutting tool interacts with the known optical surface;
converting the smoothed error map into a derived angle space corresponding to the incident angles; and
generating a corrected toolpath based on the derived angle space and applying the corrected toolpath to the machining equipment to correct the surface deviations.

2. The method of claim 1, wherein the metrology instrument is a coordinate measuring machine, interferometer, or other instrument configured to capture nanometer-level deviations.

3. The method of claim 1, further comprising a step of deriving a root mean square error from the surface error data for an overall surface quality assessment.

4. The method of claim 1, wherein the incident angles are derived from a point cloud defining a geometry of the optical parts or mold insert.

5. The method of claim 1, further comprising a step of scaling the corrected toolpath for application on surfaces with different radii.

6. The method of claim 5, wherein the scaling factor is determined by a ratio of the radii of the reference surface and the target surface.

7. The method of claim 1, further comprising a step of applying iterative corrections to the toolpath to account for cumulative tool wear.

8. The method of claim 1, wherein the corrected toolpath is applied to machining equipment configured for diamond turning, milling, grinding, or deterministic polishing.

9. The method of claim 1, wherein generating the corrected toolpath further comprises refining toolpath adjustments by scaling correction values in accordance with local incident angle data derived from the smoothed error map of the known optical surface, such that each toolpath adjustment is tailored to the incident angle at each point on both the reference surface and the target surface.

10. The method of claim 1, wherein the corrected toolpath reduces peak-to-valley error to within an acceptable tolerance level.

11. A system for correcting toolpath errors in ultra-precision machining of optical parts or mold inserts, the system comprising:
a metrology instrument configured to capture surface error data of a machined optical surface;
an error analysis module configured to smooth the surface error data and generate a smoothed error map;
a toolpath transformation module configured to derive incident angles and convert the smoothed error map into a derived angle space;
a toolpath correction module configured to generate a corrected toolpath based on the derived angle space; and
a machining equipment configured to execute the corrected toolpath for machining the optical part or mold insert.

12. The system of claim 11, wherein the metrology instrument is an interferometer capable of capturing surface deviations with nanometer accuracy.

13. The system of claim 11, wherein the error analysis module is further configured to calculate root mean square error values and peak-to-valley error values from the surface error data.

14. The system of claim 11, wherein the toolpath transformation module is configured to adjust the toolpath based on local curvature data of the optical mold insert.

15. The system of claim 11, further comprising a control system configured to monitor tool wear and coordinate real-time data flow among system components.

16. A user interface for correcting tool wear in ultra-precision machining processes, the user interface comprising:
a data input section configured to receive high-precision measurement data, including metrology data from a machined surface and point cloud data representing an optical design surface, from a metrology instrument;
a mask diameter input section configured to allow a user to define a specific region of interest on the machined surface for which toolpath corrections are to be applied;
a smoothing parameter input section configured to apply a smoothing algorithm to the high-precision measurement data to reduce noise and enhance surface deviations;
a process initiation command configured to execute a toolpath correction algorithm based on input received via the data input section, the mask diameter input section, and the smoothing parameter input section;
a status display section configured to provide real-time feedback on the progress and status of a toolpath correction process; and
a graphical display configured to present a visual representation of the surface deviations and a corrected toolpath.

17. The user interface of claim 16, wherein the graphical display includes a color-coded interferometric map of the surface deviations.

18. The user interface of claim 16, further comprising a peak-to-valley error display showing an improvement in one or more of the surface deviations after correction.

19. The user interface of claim 16, wherein the data input section is configured to accept data in multiple formats.

20. The user interface of claim 16, further comprising an export function to save the corrected toolpath for later use or analysis.
